(19) United States
(12) Patent Application Publication
(10) Pub. No.: US 2014/0289059 A1
(43) Pub. Date: Sep. 25, 2014

(54) SYSTEMS AND METHODS FOR DATA FEED MANAGEMENT

(71) Applicant: SHOPPER'S HAUL, LLC, AURORA, IL (US)

(72) Inventor: Marianne Arden Hall, Aurora, IL (US)

(21) Appl. No.: 14/214,879

(22) Filed: Mar. 15, 2014

Related U.S. Application Data
(60) Provisional application No. 61/801,677, filed on Mar. 15, 2013.

(51) Int. Cl. G06Q 30/02

(52) U.S. Cl. CPC G06Q 30/0277
USPC 705/14.73

(57) ABSTRACT

Systems and methods are provided for automatically replacing generic web address information received from a data source with individual web address information. One example computer-implemented method comprises transmitting a data request at an end of a preset time interval, and after each data request: receiving, from the data source, offer information related to a plurality of offers, each offer being associated with a generic web address; associating each offer with a respective one of a plurality of individual web addresses; modifying the offer information by replacing the generic web address for each offer with the individual web address associated with the offer; and posting the offer information on a web page, each offer being displayed with the associated individual web address.

### CROSS REFERENCE TO RELATED APPLICATION

This application claims the benefit of U.S. Provisional Patent Application No. 61/801,677 filed on Mar. 15, 2013, which is incorporated herein by reference in its entirety.

### TECHNICAL FIELD

The present invention relates to systems and methods for managing data feeds. In particular, the present invention relates to systems and methods for replacing generic web address information in a data feed with individualized web address information.

### BACKGROUND

Some companies (e.g., retail companies, coupon companies, or other merchants) provide compensation to persons or entities that become an affiliate of the company and publish the offers offered by the companies on, for example, their web page/application (e.g., shopping blog). The compensation may be awarded to the publishing person or entity (e.g., publisher) each time a customer prints an offer (e.g., coupon) posted on the publisher's web page, or clicks on an offer hyperlink posted on the publisher's web page and follows through with a purchase (e.g., retail deal). The company can track the printing and purchasing activity that is linked to each publisher by assigning the publisher with an identification number (e.g., ID) and attaching this identification number to an individualized hyperlink that is displayed with the offer on the publisher's web page.

In the coupon world, there are at least two types of coupon companies that pay a commission for coupon prints: coupon distributing companies and coupon promoting companies. Coupon distributing companies can generate and distribute coupons on a daily, weekly, monthly, etc. basis for a variety of brands and products. In some cases, the coupon distributing company may generate coupons only for a certain family of brands, a certain category of products (e.g., household products, food, etc.). In other cases, the coupon distributing company may generate coupons for any and all products available, for example, in a standard grocery store, convenience store, or the like. Coupon promoting companies, on the other hand, do not generate their own coupons, but promote the coupons distributed by the coupon distributing companies. The coupon promoting companies may receive a commission from the coupon distributing company for promoted coupons that are printed by customers. Each coupon distributing company may have several coupon promoting companies that promote their coupons. And each coupon promoting company may promote the coupons of several company distributing companies.

In some cases, publishers are not allowed to receive commission from both the coupon promoting company and the coupon distributing company for a single coupon print. That is, when posting a coupon, the publisher must choose which one of the two companies will be affiliated with the coupon. Incidentally, the commission paid by coupon promoting companies to individual coupon publishers is often higher than the commission paid by coupon distributing companies to individual coupon publishers. Thus, publishers often prefer to affiliate themselves with coupon promoting companies and publish coupons as an affiliate of the coupon promoting company.

Another restriction on coupon commissions may be that each coupon published by the publisher can only be affiliated with one coupon promoting company at a time. In some cases, publishers can receive only one commission payment from a given company during a preset length of time (e.g., 24 hours, 48 hours, etc.). Thus, no matter how many coupons affiliated with the given company are printed during the preset length of time, the publisher will only be paid for the first coupon print affiliated with the given company based on the companies terms and conditions.

Some coupon distributing companies, as well as retail companies or other merchants, can distribute its offers or coupons in the form of a data feed, such as a Really Simple Syndication (RSS) feed, which includes offer information about the offers being provided by the company. As an example, for coupon companies, the RSS feed includes specific coupon information for each coupon included in the feed.

### SUMMARY

This disclosure is defined by the appended claims. The description summarizes aspects of the embodiments and should not be used to limit the claims. Other implementations are contemplated in accordance with the techniques described herein, as will be apparent to one having ordinary skill in the art upon examination of the following drawings and detail description, and such implementations are intended to within the scope of this application.

Example embodiments provide systems and methods for automatically replacing generic web address information received from a data source with individual web address information. According to some embodiments, a data request is transmitted to a data source at an end of a preset time interval. After each data request, offer information related to a plurality of offers is received, each offer being associated with a generic web address. Also after each data request, each of the offers are associated with a respective one of a plurality of individual web addresses, and the offer information is modified by replacing the generic web address for each offer with the individual web address associated with the offer. The modified offer information is posted on a web page, each offer being displayed with the associated individual web address.

In some embodiments, a computer-implemented method for posting previously-posted data on a web page includes transmitting a data request to a web page at an end of a preset time interval; and after each data request: receiving, from the web page, previously-posted offer information related to a plurality of offers, and posting the received offer information on the web page. According to some aspects, the previously-posted offer information includes individual web addresses for each of the offers. According to further aspects, the individual web addresses include at least one of offer-identifying information, company-identifying information, or user-identifying information.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 illustrates a system in accordance with one embodiment.

FIG. 2 illustrates one form of a computer or server of FIG. 1 for implementing one embodiment.

FIG. 3 illustrates a flowchart including operations that may be implemented using the system of FIG. 1.

FIGS. 4, 5A, 5B, 5C, 6A, 6B, and 6C are exemplary screenshots of a software application interface related to the system of FIG. 1.

FIGS. 7 and 8 illustrate additional flowcharts including operations that may be implemented using the system of FIG. 1.

Illustrative and exemplary embodiments of the invention are described in further detail below with reference to and in conjunction with the figures.

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

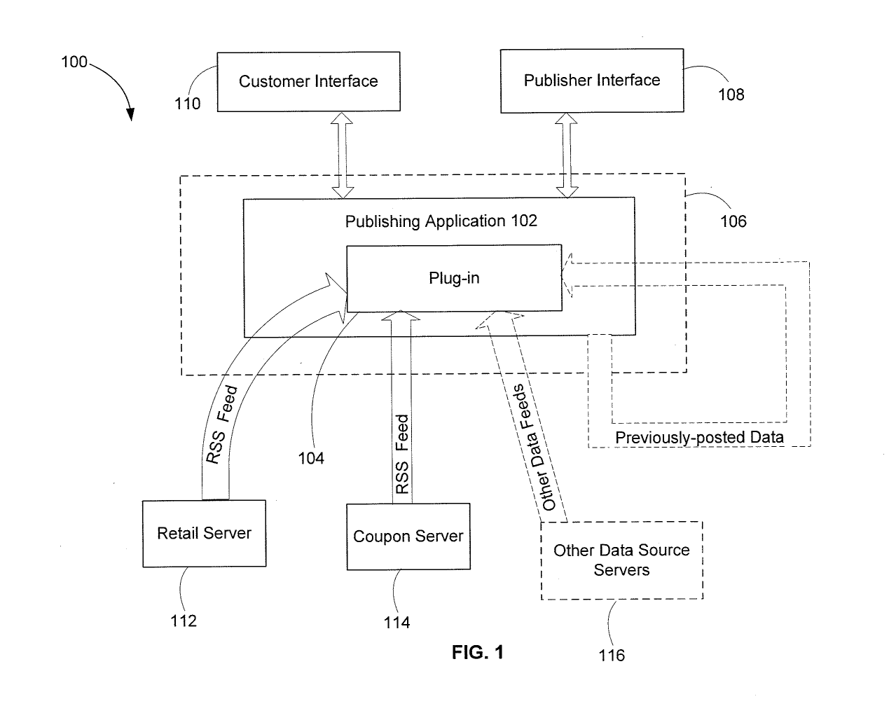

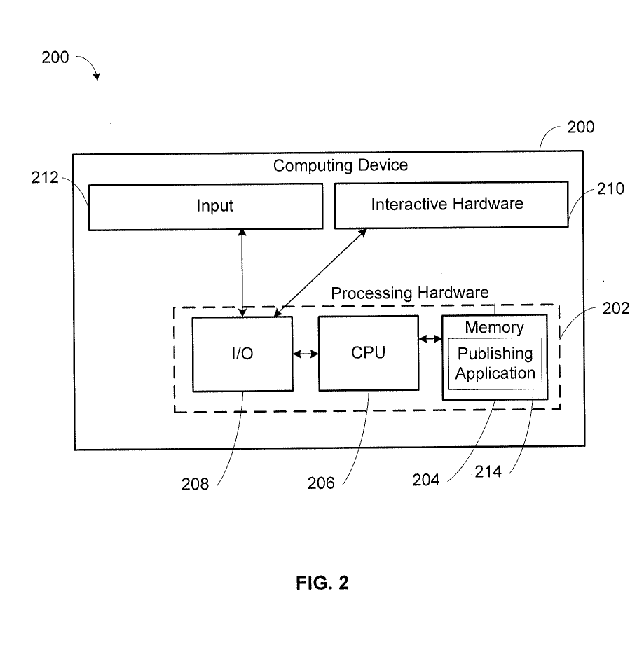

Referring to FIG. 1, a system diagram illustrates an embodiment of a computer-networked system 100 for managing data feeds in accordance with one or more of the principles described herein. The system 100 may include modules and components that are connected through a network, such as the Internet, which can facilitate communications through secure channels. Various components of the system 100 can be implemented using software executable by one or more computers (e.g., servers, personal computers, computing devices, mobile devices, etc.). An exemplary computer is shown in FIG. 2, as a computing device 200, and will be discussed in more detail below.

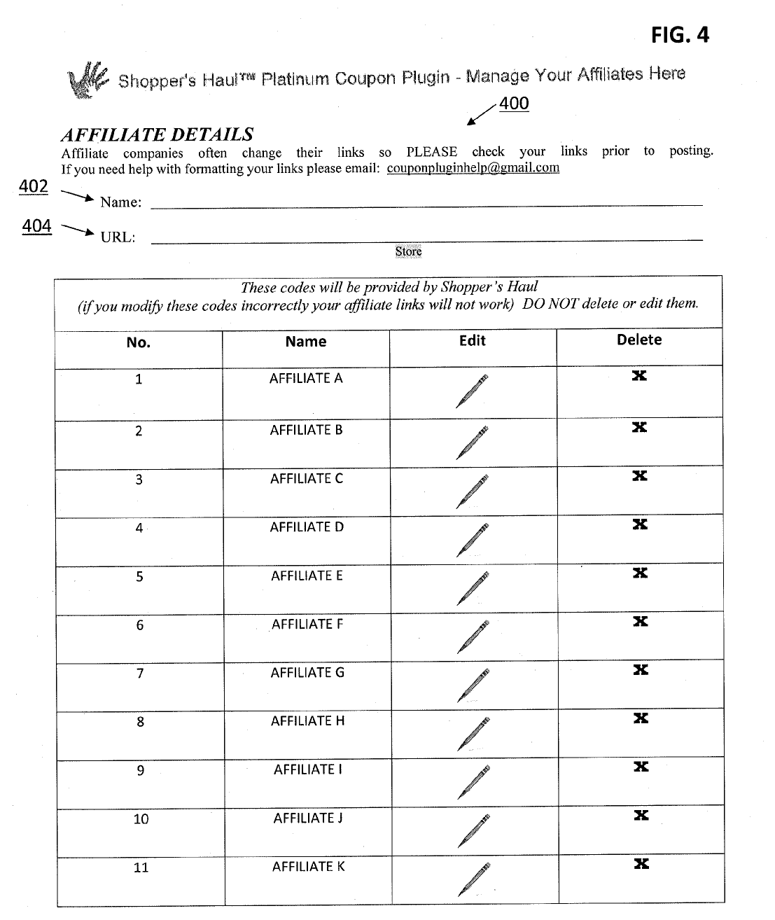

As illustrated in FIG. 1, the system 100 includes a data feed publishing software application 102 (hereinafter “publishing application 102”) which includes or is associated with a data feed plug-in 104 (hereinafter “plug-in 104”), each of which may reside on at least one server 106 and/or may reside on various interface devices, for example, by being downloaded through the Internet or other network, or copied into memory on those interface devices through transport on a computer readable medium. For example, a data feed publisher may interact with the publishing application 102 through a publisher interface 108. Similarly, a customer (e.g., a person interested in printing coupons posted by the publisher) may interact with the publishing application 102 through a customer interface 110. In one embodiment, the interfaces 108, 110 can be software programs designed to operate on respective interface devices and tailored to interact and exchange data with the publishing application 102. These software programs can include mobile applications that can be executed on smart phone, mobile device, and the like. In some embodiments, the interfaces 108, 110 can reside only on the server 106. In some embodiments, the interfaces 108, 110 can be standard web browser software programs, such as Internet Explorer, Firefox, Chrome, or Safari. In such embodiments, the customer or publisher uses the browser interface to interact with the publishing application 106. Further, according to these embodiments, the publishing application 102 can be implemented as a web page hosted by the server 106 or other computing device. For example, FIGS. 4, 5A-5C, and 6A-6C show exemplary screenshots of a web page implementing the publishing application 102 and the plug-in 104. In one exemplary embodiment, the publisher interface 108 may be a portal through which the publisher can manage the plug-in 104 (e.g., activate or de-activate the plug-in 104).

As illustrated in FIG. 1, the system 100 further includes various servers that communicate with the publishing application 102, and more specifically, the plug-in 104. As shown, the system 100 can include a retail server 112 that sends an RSS feed related to retail deals to the plug-in 104. The retail server 112 can be affiliated with, or owned, operated, and/or controlled by, one or more retail companies, including brick and mortar stores, online shopping sites, etc. The retail deals can include savings promotions, coupons, deals, and other offers provided by the affiliated retail company. The retail deals may be presented in the form of a hyperlink on the publisher's web page/application. Clicking the hyperlink can take the customer to another web page for making a purchase using the selected deal. In addition; or in the alternative, system 100 can include a coupon server 114 that sends an RSS feed related to coupons to the plug-in 104. The coupon server 114 can be affiliated with, or owned, operated, and/or controlled by, one or more coupon companies (e.g., a coupon clearinghouse) that offer coupons for various products. Coupons and retail deals are collectively and individually referred to as “offers” in this document, and vice verse.

According to some embodiments, the system 100 can include other servers 116 that are affiliated with, or owned, operated, and/or controlled by, other data sources and provide other data feeds (e.g., news feeds, advertising feeds, and the like) to the plug-in 104. In some embodiments, the publisher may generate one or more of the data feeds provided to the plug-in 104. As shown in FIG. 1, according to one embodiment, the plug-in 104 can also receive a previously-posted data feed directly from the publishing application 102. For example, data that was posted on the publishing application 102 at an earlier date or time may be pulled from the publishing application 102 by the plug-in 104 and reposted on, for example, the publisher's web page as new data. The publisher can use this feature to draw a customer's attention to older posts, especially when the publisher's web page includes a large number of posts, causing older posts to be buried near the bottom of the page.

In some cases, data feed publishers have an incentive to publish as many offers as possible, so as to increase the chances of an offer print or other form of offer redemption, and to publish offers affiliated with as many offer promoters (e.g., coupon promoting companies) as possible, so as to increase the chances of getting paid for a given offer print. For example, each offer promoter may pay an affiliated publisher only for the first offer print or redemption for a given offer. Thus, even if 100 customers redeem an offer through the publisher's web page, the publisher is paid only for the first customer's redemption. In such cases, in a given length of time, publishers can be paid a maximum commission of C*A, where C represents the amount of commission paid for the first coupon print by the offer promoters, and A represents the number of offer promoters with which the publisher is affiliated.

Offer distributors (e.g., coupon distributing companies, retail companies, etc.) may distribute offer information in the form of a data feed. In some cases, offer distributors can include an individual that generates her own data feed and distributes the data feed to other publishers. As an example, the data feeds can be an RSS feed written in Extensible Mark-up Language (XML) and including several data tags that surround the data elements or content. The data tags (e.g., <couponid> . . . </couponid>) define or explain the type of data, or content, appearing between a pair of tags (e.g., 17655187). The following is XML from an example RSS feed and shows the information for one “item” or offer. As will be appreciated, other tags could be included, and this disclosure is not limited to the specific tags used in the below example.

### Example 1

```
<item>
      <couponid>17655187</couponid>
      <link>http://www.coupondistributer.com/alink.asp?go=
13903xh2010&plid=RSS&crid=RSS&cid=17655187&alt=yes</link>
      <description>$1.00 off TWO BOXES Cheerios
      cereals</description>
      <image>http://cdn.coupondistributer.com/
insight.coupondistributer.com/COS20/_{—Cache/}_ImageCache/187/
17655187.gif</image>
      <activedate>3/1/2013 12:01:00 AM</activedate>
      <shutoff>3/31/2013 11:59:00 PM</shutoff>
      <expiration>4/30/2013 11:59:00 PM</expiration>
      <majorCategory>Foods</majorCategory>
      <minorCategory>Breakfast</minorCategory>
      <brand>Big G Cereals</brand>
</item>
```

As seen in Example 1 above, the data tags relate to varies characteristics about the offer (or in this case, coupon), including an identification number of the offer, a description of the offer, various dates related to when the offer becomes active, expires, or can no longer be displayed, categories associated with the product included in the offer (e.g., Food, Books, Household, etc.), and a product brand. Further, the XML code can include an image of the offer or the product included in the offer, and a Uniform Resource Locator (URL), or link, for accessing the offer. The URL included in the offer information is tied to the offer distributor (e.g., http://www.coupondistributer.com/ . . . ), and when selected or clicked, takes the customer to a web page (e.g., the coupon distributing company's web page) where the offer can be redeemed (e.g., the coupon can be printed, the retail deal can be claimed, etc.).

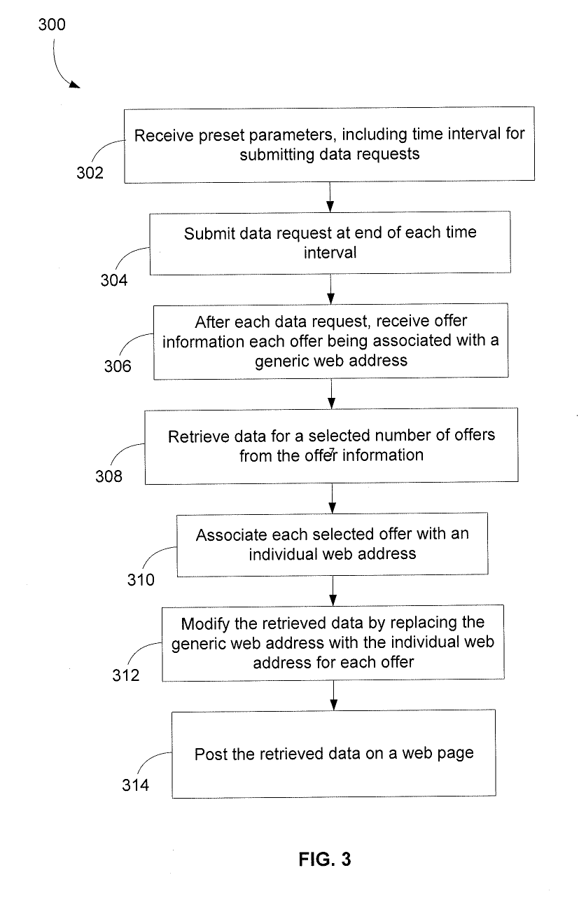

Referring now to FIG. 3, shown is a process 300 using the system 100 for managing data feeds to be posted on the publishing application 102. According to some aspects, the process 300 includes operations that can be carried out by the publishing plug-in 104. For example, the publishing plug-in 104 can be configured to receive RSS feeds or other data feeds from one or more data sources and format the offer information included in the data feed for presentation on a web page or application (e.g., a shopping blog, a deal-delivering mobile application, etc.). The process 300 can begin at step 302 where the publishing plug-in 104 receives preset parameters, including a time interval for submitting data requests, from a user of the publishing plug-in 104 (e.g., a publisher). The preset parameters can be entered by the publisher (via, for example, publisher's interface 108 of FIG. 1) during a set-up mode of the plug-in 104. FIGS. 4, 5A-5C, and 6A-6C show example screenshots for entering the preset parameters and otherwise configuring the settings of the plug-in 104.

For example, the preset parameters can include information about the companies or merchants that the publisher is affiliated with (e.g., offer/coupon companies, including offer/coupon distributers and offer/coupon promoters, retail companies, and other data sources) and a URL that is associated with each company. FIG. 4 illustrates an example affiliate management page 400 with a data field 402 for entering the name of each company that the publisher is affiliated with and a data field 404 for entering the appropriate URL for each company. The plug-in 104 stores this information for later use, as described below. An example of a company URL is shown below in Example 2. The URL can identify the coupon promoting company or other offer promoter and, when populated with appropriate identifying information, can be used to create an individual web address for each offer, as described below.

### Example 2

http://couponpromotingcompany.com/z/29761/{publisher_code}/cid={id} &alt=yes

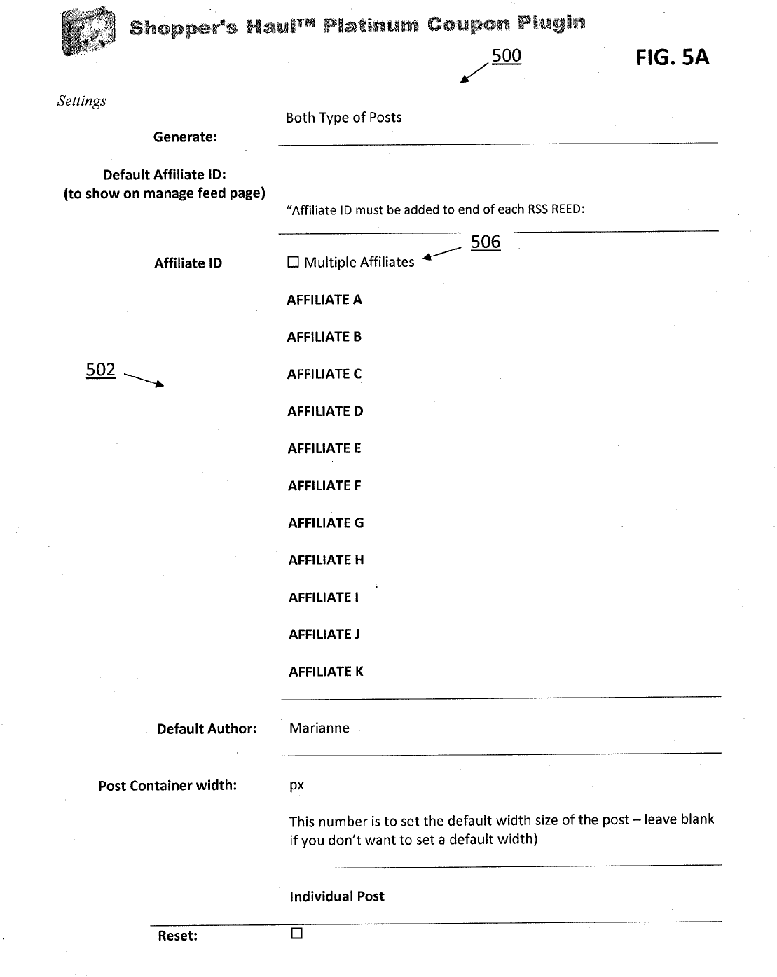

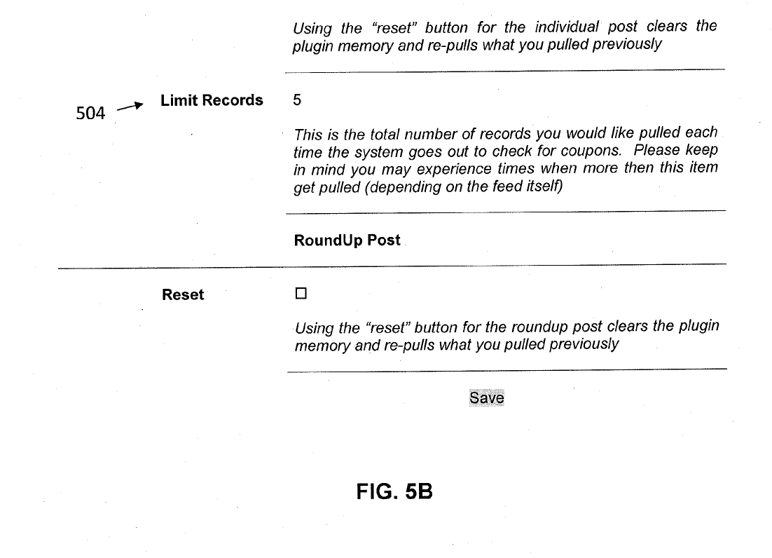

The preset parameters can further include the publisher's identifying information (e.g., publisher ID) for each company and the number of offers to post to the publisher's web page during each pull cycle (to be described in more detail below). FIGS. 5A, 5B, and 5C illustrate an example post settings page 500 that includes data fields 502 for entering the publisher ID for each company (FIG. 5A) and a data field 504 for entering the number of offers that should be posted during each pull (FIG. 5B). The page 500 further includes a data field 506 for indicating whether multiple affiliates should be used. When the data field 506 is selected, the list of affiliates appears, as shown in FIG. 5A. When data field 506 is not selected, the list of affiliates does not appear, as shown in FIG. 5C, and instead, a data field 508 appears indicating the “DO NOT SWAP” selection. By selecting the data field 506, the publisher indicates to the plug-in 104 that each coupon posted on the publisher's web page should be associated with a different company from the list appearing in data fields 502, so that the publisher can potentially be paid by the selected affiliate for any given print. To maximize the publisher's revenue, a publisher can enter a number of offers in data field 504 that is equal to the number of affiliated companies in data fields 502. When the data field 506 is not selected, the plug-in 104 will associate each coupon with the same company, so that the publisher will only be paid by that one company.

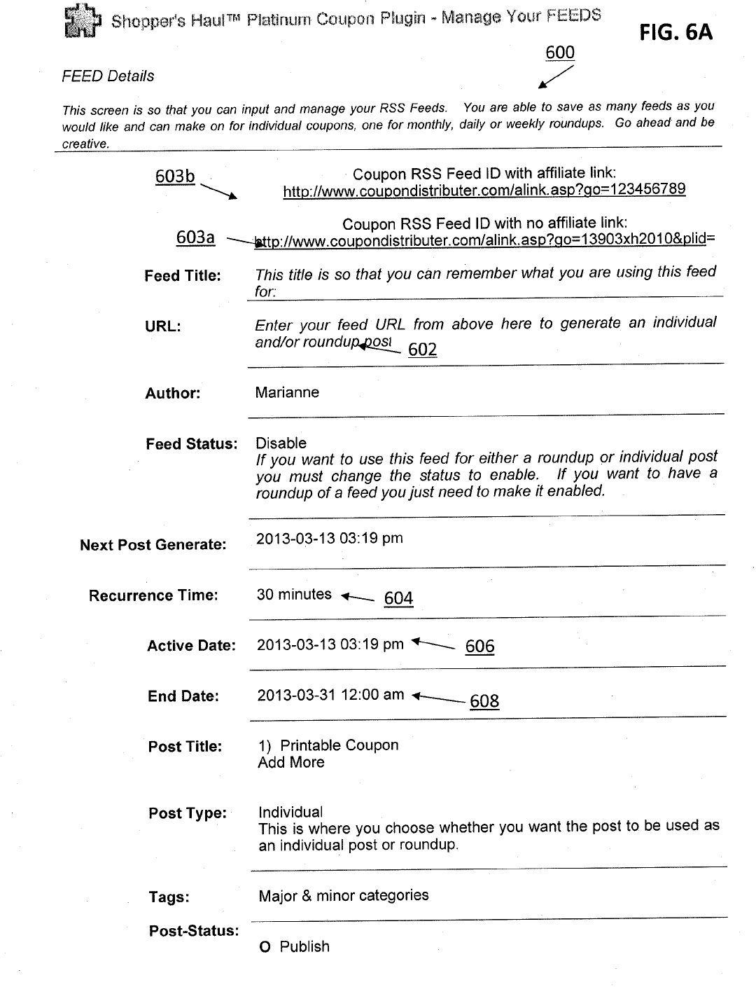

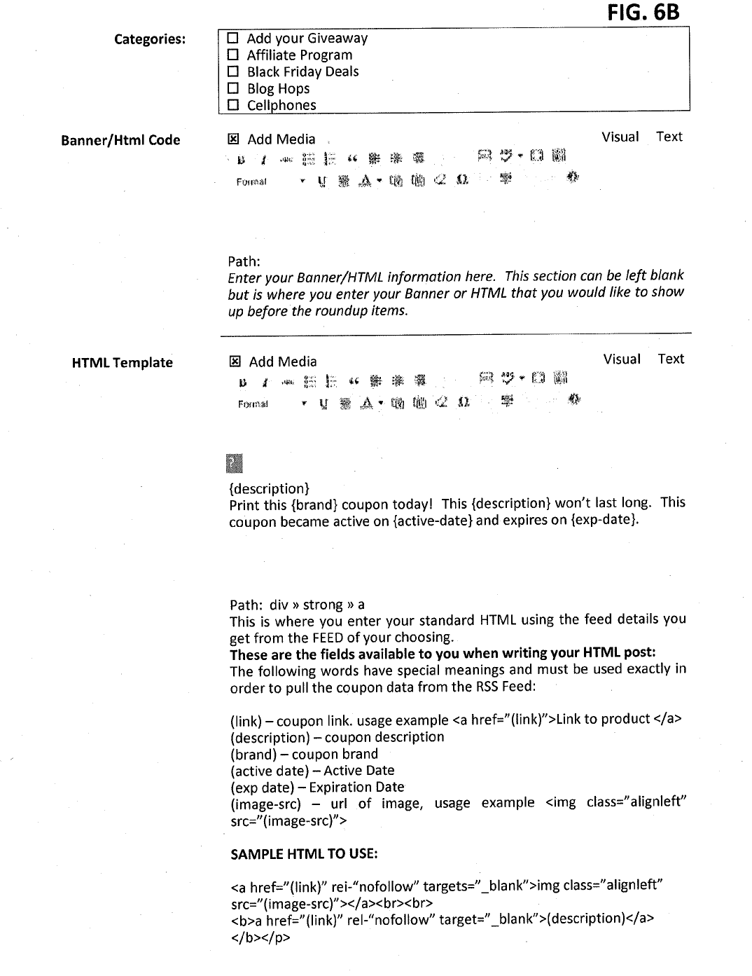

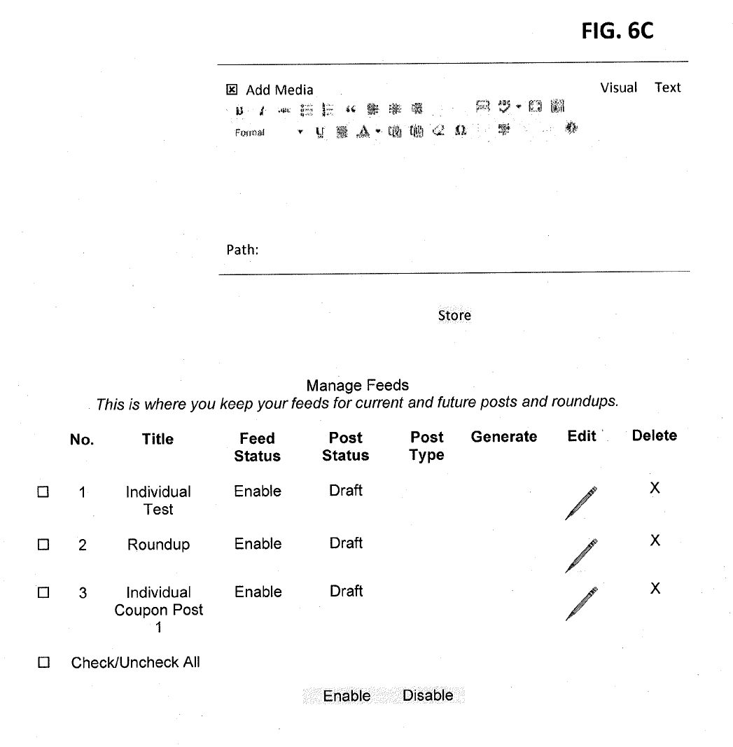

The preset parameters can also include details about which data feed to use, what information to retrieve from the data feeds for each posting on the publisher's web page, and how often data should be pulled from the data feed. FIGS. 6A, 6B, and 6C illustrate an example feed management page 600 that includes a data field 602 for entering a URL for the data feed that the publisher wants to use. For example, the URL entered in data field 602 may be the URL 603a for the RSS feed transmitted by the offer distributor. However, this RSS feed URL 603a (also referred to herein as a generic web address) is not specifically affiliated with a publisher, and therefore, a publisher will not receive credit for any coupons printed through the RSS feed URL 603a. To ensure that publishers are paid for coupon prints, the generic web address 603a can be modified to include a publisher's identifying information. The identifying information can include a unique ID number provided by the offer distributor for signing up with the company. When clicked and printed by a customer, the modified generic web address 603b provides the publisher with credit or commission for the click through from the coupon distributing company.

The page 600 further includes data field 604 for entering a recurrence time, which determines an interval of time between each data pull (e.g., each instance of requesting data from the data feed). The time interval can be set for any time, including, e.g., hourly, daily, monthly, etc. For example, referring again to FIG. 3, at step 304, the plug-in 104 submits a data request to the data source (e.g., the RSS feed source) at the end (or beginning) of each time interval, the time interval being determined by the preset parameter entered in data field 604. The process 300 continues to step 306, where, after each data request, the plug-in 104 receives the RSS feed data, which includes offer information for a plurality of offers. This pull cycle can continue for the time period indicated in data fields 606 (active date) and 608 (end date).

After step 306, the process 300 continues to step 308, where the plug-in 104 retrieves, from the RSS feed, data for a selected number of offers from the offer information. The selected number of offers can be determined by the preset parameter entered into data field 504 in FIG. 5B (e.g., the number of offers to pull per pull cycle). The data retrieved from the RSS feed may be similar to the information shown in Example 1 above, where data content is defined by XML data tags. The plug-in 104 can be configured to read the data tags in order to find information that it needs. For example, if the plug-in 104 needs the coupon identification number, the plug-in 104 can locate this information within the RSS feed data by finding the beginning data tag <couponid> and the ending data tag <couponid>, the relevant content being located between the two data tags. As another example, the plug-in 104 can locate a web address associated with the coupon by looking at the content between data tags <link> and </link> within the offer information associated with that coupon.

After step 308, the process 300 continues to step 310, where the plug-in 104 associates each offer selected in step 308 with an individual web address. When the offer information is received from the RSS feed at step 306, each of the offers may be associated with a generic web address, such as the URLs 603a or 603b in FIG. 6A. The generic web address may be tied to the RSS feed and the company that originally distributed the RSS feed. As described above, this generic web address can be modified to include identifying information, such as the publisher's ID for that company, so that the publisher receives a commission for offers redeemed from the offer distributor. However, even the modified generic web address can only provide a commission from the offer distributor.

In order to receive credit or commission from an offer promoter, instead of the offer distributor, the plug-in 104 is configured to associate each offer selected in step 308 with an individual web address (step 310) and automatically replace the generic web address with the individual web address (step 312). As shown in Example 2 above, the individual web address is tied to the offer promoter (e.g., http://couponpromotingcompany.com . . . ) and includes identifying information about the publisher (e.g., the publisher's code at the coupon promoting company) and identifying information about the offer (e.g., coupon ID). The plug-in 104 can be configured to automatically pull relevant content from the offer information received via the RSS feed and/or the preset parameters entered by the publisher and insert the pulled content into the data tag portions of the individual web address (e.g., publisher's code into {publisher_code} and offer/coupon ID into {id}). For example, the individual web address that is associated with a first coupon will have the coupon ID of that first coupon.

At step 310, each selected offer is first associated with one of the companies that the publisher is affiliated with, and then the selected offer is associated with the individual web address that corresponds to the associated company. For example, the publisher may be affiliated with five companies, each company having its own individual web address. Accordingly, the publisher may set the number of posted offers as 5 in data field 504. Thus, in every pull cycle (or after each data request), the plug-in 104 pulls or retrieves 5 offers from the RSS feed provided by, for example, the coupon server 114. The plug-in 104 then assigns an offer promoter to each of the 5 offers, and correspondingly associates each of the offers with the individual web address of the assigned company. The plug-in 104 makes sure to assign each company only once because, for example, with some companies, the publisher may only be paid for the first coupon print. After the next data request, the plug-in 104 will repeat the same steps: pull 5 offers from the RSS feed, assign 5 companies to the 5 offers, and associate each offer with the individual web address of the assigned company, and so forth. At step 312, the plug-in 104 can modify the offer information for each offer to include the individual web address (example 2), instead of the generic web address (URL 603a, 603b), prior to posting the offer on the publisher's web page at step 314, so that each of the selected offers is posted with the individual web address. Accordingly, the publisher has an increased probability of getting paid for each coupon posted on her web page. To further increase profitability, the plug-in 104 may be configured to “swap” or rotate which companies are assigned to the offers pulled from the RSS feed. The swapping may occur after a predetermined number of data requests (e.g., 1, 2, 5, etc.).

According to some embodiment, the plug-in 104 can receive preset parameters related to presentation and formatting of the data retrieved from the RSS feed. As shown in FIGS. 6A, 6B, and 6C, such preset parameters can include parameters related to presenting the offer information on the web page (e.g., text size, text color, post width, image size, image colors, etc.), descriptive information to be added to the offer information, images to be added to the offer information, and others. At step 314, the selected offers may be posted on the publisher's web page according to these preset parameters.

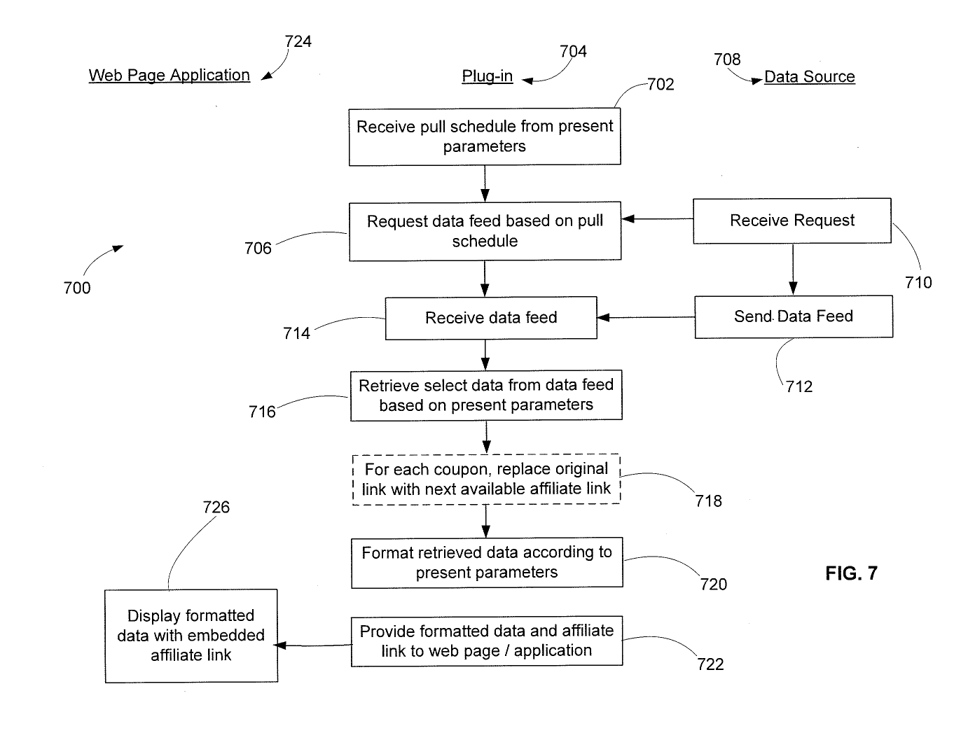

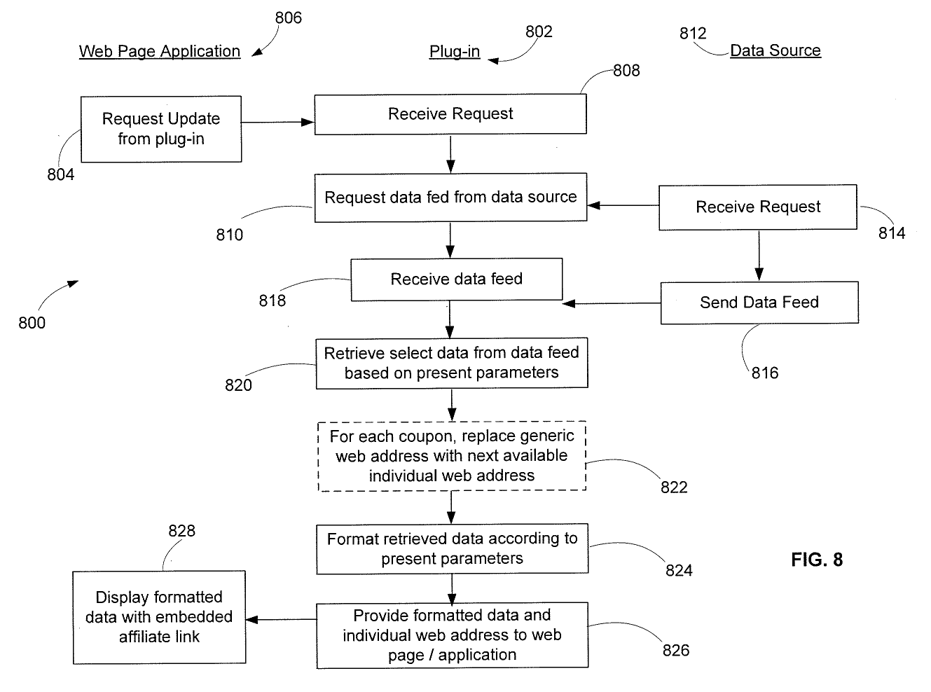

Referring now to FIGS. 7 and 8, show are flow diagrams of exemplary operations between the publisher's webpage or mobile application, the plug-in 104, and one of the data sources, such as coupon server 114, in accordance with some embodiments. FIGS. 7 and 8 are substantially similar except for the first few steps. Also, many of the steps in FIGS. 7 and 8 are similar to those described above with respect to FIG. 3. In FIG. 7, the operations 700 begin at step 702, the plug-in 704 receives a pull schedule from the preset parameters entered by the publisher during, for example, step 302 of the process 300. For example, the pull schedule can be determined by the time interval entered in data field 604 in FIG. 6A. Based on this pull schedule, at step 706, the plug-in 702 requests a data feed from a data source 708. The data source receives the request at step 710 and sends the data feed to the plug-in 704 at step 712. At step 714, the plug-in 704 receives the data feed, and at step 716, the plug-in 704 retrieves selected offer data from the data feed, the selected offer data being determined by the preset parameters, including how many offers to retrieve from the data feed. According to some embodiments, the operations 700 can include a step 718 where for each offer, the plug-in 704 replaces an original link (e.g., generic web address) with a next-available affiliate link (e.g., individual web address). If the publisher does not enter any affiliate links, then this step may be skipped. At step 720, the plug-in 704 formats the retrieved data according to the preset parameters. At step 722, the plug-in 7-4 provides the formatted data and the affiliate link associated with each offer to a webpage/application 724 in which the plug-in 704 resides. The webpage/application 724 then displays the received data at step 726.

In FIG. 8, operations 800 refer to a situation in which there is not pull schedule (e.g., the publisher did not enter a value in data field 602), or when the plug-in 802 is not pulling data from the RSS feed correctly. At step 804, the web page 806 requests an update from the plug-in 802. The plug-in 802 receives the request at step 808, and at step 810, sends a data request to a data source 812. The data source 812 receives the request at step 814 and sends the data feed to the plug-in 802 at step 816. Steps 818 to 828 correspond to steps 714 to 722 and 726, respectively.

Referring back to FIG. 2, shown is the computing device 200 with processing hardware 202. The processing hardware 202 can include a memory 204 (e.g., random access memory (RAM, such as DRAM, SRAM, SDRAM, etc.) and/or nonvolatile memory elements (e.g., ROM, hard drive, tape, CDROM, etc.)), a central processing unit (CPU) 206 (e.g., a microprocessor, and the like), and an I/O portion 208. The CPU portion 206 can be any computer-processing unit from a singular microchip to extensive microchip configuration. Moreover, the memory portion 204 may incorporate electronic, magnetic, optical, and/or other types of storage media, and can have a distributed architecture where various components are situated remotely from one another, but are still accessed by the microprocessor portion 206. The computing device 200 can further include an interactive hardware portion 210 (e.g., a keyboard, a mouse, and the like) and an input portion 212 (e.g., a camera, a scanner, and the like). The interactive hardware portion 210 and the input portion 212 are coupled to the I/O portion 208 such that a command or other input entered or provided by a user through the interactive hardware portion 210 or the input portion 212 will be forwarded to the I/O portion 208, to the microprocessor portion 206, and then to memory portion 204.

In some embodiments, all or portions of the system 100 may be implemented in software as an executable program and executed by a computer such as the computing device 200. In such embodiments, all or portions of the system 100 may be stored in the memory 204 of the computing device 200. For example, according to one embodiment, the executable program can include the data feed publishing software application 102, 214 and the data feed plug-in 104, each of which can be stored in the memory portion 204, as illustrated in FIGS. 1 and 2, or in any other computer hardware device. The executable programs 318 can be implemented in software, firmware, hardware, or a combination thereof. When the computing device 200 is in operation, the CPU portion 206 can be configured to execute software stored within the memory 204, to communicate data to and from the memory 204, and to generally control operations of the computer 102 pursuant to the software.

When the data feed publishing software application 102, 214 and/or the data feed plug-in 104 are implemented in software, they can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The data feed publishing software application 102, 214 and/or the data feed plug-in 104 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

1. A computer-implemented method for automatically replacing generic web address information received from a data source with individual web address information, the method comprising:
transmitting, from a processor, a data request to a data source at an end of a preset time interval; and
after each data request:
receiving, by the processor, offer information related to a plurality of offers, each offer being associated with a generic web address,
associating, by the processor, each of the offers with a respective one of a plurality of individual web addresses,
modifying, by the processor, the offer information by replacing the generic web address for each offer with the individual web address associated with the offer, and
posting, by the processor, the modified offer information on a web page, each offer being displayed with the associated individual web address.

2. The method of claim 1, wherein the associating each offer includes:
determining whether each of the individual web addresses has been associated with an offer; and
if an individual web address is unassociated, associating said individual web address with an offer.

3. The method of claim 1, wherein each individual web address includes at least one of offer-identifying information, company-identifying information, or user-identifying information.

4. The method of claim 3, wherein the user-identifying information identifies a user associated with the web page.

5. The method of claim 4, wherein the company-identifying information identifies a company affiliated with the user.

6. The method of claim 5, wherein a number of individual web addresses is related to the number of companies affiliated with the user.

7. The method of claim 3, wherein the offer-identifying information identifies the offer associated with the individual web address.

8. The method of claim 1, wherein the offer information is an RSS feed provided by the data source.

9. The method of claim 1, further comprising formatting the offer information according to preset parameters.

10. A system for automatically replacing generic web address information with individual web address information, the system comprising:
a memory configured to store offer information received from a data source; and
a processor in communication with the memory, the processor being configured to execute the program code that is configured to:
transmit a data request at an end of a preset time interval; and
after each data request:
receive, from the data source, offer information related to a plurality of offers, each offer being associated with a generic web address,
associate each of the offers with a respective one of a plurality of individual web addresses,
modify the offer information by replacing the generic web address for each offer with the individual web address associated with the offer, and
post the offer information on a web page, each offer being displayed with the associated individual web address.

11. The method of claim 1, further comprising: receiving preset parameters for managing offer information provided by a data source, the preset parameters including a time interval for submitting data requests to the data source and formatting details for posting the retrieved data.

12. The method of claim 11, further comprising: retrieving a subset of the plurality of offers from the offer information, the subset of offers being determined by the preset parameters, wherein the subset of offers are posted on the web page with associated individual web addresses.

13. A computer-implemented method for posting previously-posted data on a web page, the method comprising:
transmitting a data request to a web page at an end of a preset time interval; and
after each data request:
receiving, from the web page, previously-posted offer information related to a plurality of offers, and
posting the received offer information on the web page.

14. The method of claim 13, wherein the previously-posted offer information includes individual web addresses for each of the offers.

15. The method of claim 14, wherein each of the individual web addresses includes at least one of offer-identifying information, company-identifying information, or user-identifying information.
